(19) United States
(12) Patent Application Publication
(10) Pub. No.: US 2020/0349359 A1
(43) Pub. Date: Nov. 5, 2020

(54) DYNAMIC WORKSTATION ASSIGNMENT

(71) Applicant: Xinova, LLC, Seattle, WA (US)

(72) Inventor: Noam HADAS, Tel-Aviv (IL)

(73) Assignee: Xinova, LLC, Seattle, WA (US)

(21) Appl. No.: 16/957,128

(22) PCT Filed: Jan. 4, 2018
(86) PCT No.: PCT/US18/12428

§ 371 Date: Jun. 23, 2020

(51) Int. Cl. G06K 9/00; G06F 21/32; H04N 7/18

(52) U.S. Cl. CPC G06K 9/00771; G06K 9/00362; G06F 2221/2113; G06F 21/32; H04N 7/185; G06K 9/00335

(57) ABSTRACT

Technologies are generally described for adjustment of displayed content based on recognition of viewer. In some examples, content that may include data, as well as, control elements associated with functionality of a surveillance system. The content may be displayed to a viewer based on the viewer's credentials. Responsive to detection of another viewer, the displayed content may be modified based on credentials of the other viewer. Viewers may be detected through a variety of techniques and displayed content may be associated with different authority levels. In other examples, content may be blocked from display if a viewer in a restricted list is detected in view of a display device.

### BACKGROUND

Unless otherwise indicated herein, the materials described in this section are not prior art to the claims in this application and are not admitted to be prior art by inclusion in this section.

Captured content by the surveillance cameras, as well as, additional information such as feedback from in-the-field personnel, background information, etc. may be provided to a surveillance control room. In the surveillance control room, a number of workstations may be operated by multiple security personnel of different levels in the organization. Each personnel may have different permissions in the system to see and control different content and functions. In order to prevent unauthorized access to some of the displayed content and functions, each security personnel may be assigned to a workstation and required to log in using his/her credentials. Thus, the system may determine which level of access may be granted to that workstation based on the signed in security personnel's credentials.

In some situations, a lower ranking security personnel may call a supervisor to look at a specific displayed content. If the supervisor decides to take a particular action when examining the displayed content, he or she may need to return to their workstation, ask the security personnel to route the content to their workstation, and then perform the action. Alternatively, the supervisor may ask the security personnel to log out, and log in instead to gain access the supervisory control level. Both options may take time, which may be critical in starting an appropriate response to a security development.

### SUMMARY

The present disclosure generally describes techniques to adjust displayed content based on recognition of viewer in surveillance control environments.

According to some examples, a method to provide security based content control based on a security verified viewer is described. The method may include providing a first content to display on a display device, wherein the first content is selected based on an authenticated credential associated with a first person within a field of view of the display device, detecting a second person within the field of view of the display device, authenticating a credential of the second person by an image based recognition of the second person; and responsive to the authentication of the credential of the second person, providing a second content to display on the display device, wherein the second content is associated with the authenticated credential of the second person.

According to further examples, an apparatus configured to provide security based content control based on a security verified viewer is described. The apparatus may include a communication interface configured to facilitate communication between the apparatus and a surveillance system server, a display device, an image capture device, a memory configured to store instructions associated with a surveillance application; and a processor coupled to the communication interface, the display device, the image capture device, and the memory. The processor may configured to execute the surveillance application and perform actions comprising: provide a first content to display on the display device, wherein the first content is selected based on an authenticated credential associated with a first person within a field of view of the display device, detect a second person within the field of view of the display device through the image capture device, authenticate a credential of the second person by an image based recognition of the second person; and responsive to the authentication of the credential of the second person, provide a second content to display on the display device, wherein the second content is associated with the authenticated credential of the second person.

According to yet other examples, a surveillance system configured to provide security based content control based on a security verified viewer is described. The surveillance system may include one or more surveillance cameras communicatively coupled to a workstation, a data store communicatively coupled to the workstation and configured to store surveillance related data; and the workstation for management of the surveillance system. The workstation may include a communication interface configured to facilitate communication between the apparatus and a surveillance system server, a display device, an image capture device, a memory configured to store instructions associated with a surveillance application; and a processor coupled to the communication interface, the display device, the image capture device, and the memory. The processor may be configured to execute the surveillance application and may perform actions including: provide a first content to display on the display device, wherein the first content is selected based on an authenticated credential associated with a first person within a field of view of the display device, detect a second person within the field of view of the display device through the image capture device, authenticate a credential of the second person by an image based recognition of the second person; and responsive to the authentication of the credential of the second person, provide a second content to display on the display device, wherein the second content is associated with the authenticated credential of the second person.

According to further examples, a method to provide content control based on a verified viewer is described. The method may include providing a first content to display on a display device, wherein the first content is selected based on an authenticated credential associated with a first person within a field of view of the display device, detecting a second person within the field of view of the display device, authenticating a credential of the second person by an image based recognition of the second person; and responsive to the authentication of the credential of the second person, providing a second content to display on the display device, wherein the second content is associated with the authenticated credential of the second person.

According to yet other examples, an apparatus configured to provide content control based on a verified viewer is described. The apparatus may include a communication interface configured to facilitate communication between the apparatus, a content server, and an authentication server, a display device, an image capture device, a memory configured to store instructions associated with a content display application; and a processor coupled to the communication interface, the display device, the image capture device, and the memory. The processor may be configured to execute the content display application and perform actions include provide a first content to display on the display device, wherein the first content is selected based on an authenticated credential associated with a first person within a field of view of the display device, detect a second person within the field of view of the display device through the image capture device, authenticate a credential of the second person by an image based recognition of the second person; and responsive to the authentication of the credential of the second person, provide a second content to display on the display device, wherein the second content is associated with the authenticated credential of the second person.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example environment, where adjustment of displayed content based on recognition of viewer may be implemented;

FIG. 2 includes a conceptual illustration of another example environment, where adjustment of displayed content based on recognition of viewer may be implemented;

FIG. 3 illustrates an example scenario where displayed content in a surveillance control room may be adjusted based on recognition of viewer;

FIG. 4 illustrates additional example scenarios where adjustment of displayed content based on recognition of viewer may be controlled to prevent unauthorized viewing;

FIG. 5 illustrates an example flow of information in an example system that includes surveillance data sources, processing servers, and displays of a control room;

FIG. 6 illustrates a computing device, which may be used for adjustment of displayed content based on recognition of viewer;

FIG. 7 is a flow diagram illustrating an example method for adjustment of displayed content based on recognition of viewer that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to adjustment of displayed content based on recognition of viewer in surveillance control environments.

Briefly stated, technologies are generally described for adjustment of displayed content based on recognition of viewer. In some examples, content that may include data, as well as, control elements associated with functionality of a surveillance system. The content may be displayed to a viewer based on the viewer's credentials. Responsive to detection of another viewer, the displayed content may be modified based on credentials of the other viewer. Viewers may be detected through a variety of techniques and displayed content may be associated with different authority levels. In other examples, content may be blocked from display if a viewer in a restricted list is detected in view of a display device.

In the following figures and diagrams, the positioning, structure, and configuration of example systems, devices, and implementation environments have been simplified for clarity. Embodiments are not limited to the configurations illustrated in the following figures and diagrams. Moreover, example embodiments are described using humans as tracking targets in specific example surveillance environments. Embodiments may also be implemented in other types of environment for tracking animals, vehicles, or other mobile objects using the principles described herein.

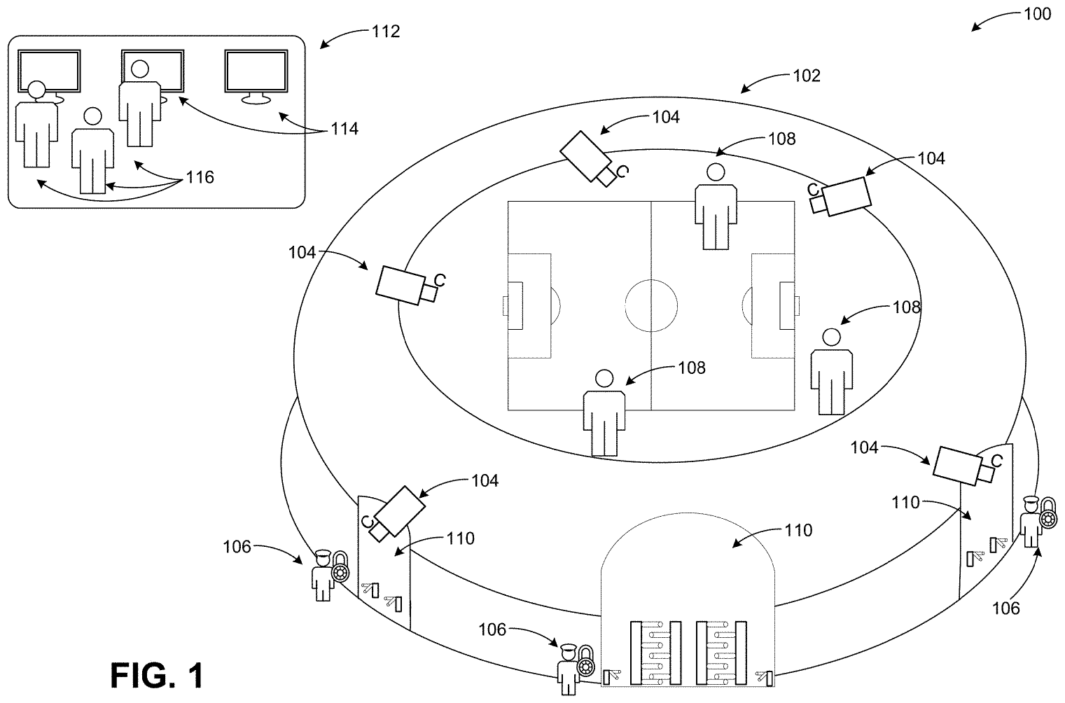

FIG. 1 includes a conceptual illustration of an example environment, where adjustment of displayed content based on recognition of viewer may be implemented, arranged in accordance with at least some embodiments described herein.

As shown in diagram 100, a surveillance system for adjustment of displayed content based on recognition of viewer may be implemented in a surveillance environment such as a sports venue 102 and include a control center 112, where personnel 116 may observe captured videos and other content of the surveillance environment on display devices 114. The surveillance system may also include a number of image capture devices 104 and “on the ground” security personnel 106. The security personnel 106 may be positioned at strategic locations such as entrance/exit gates 110 to be able to observe people 108 attending an event at the surveillance environment.

The image capture devices 104 may include a stationary camera, a mobile camera, a thermal camera, or a camera integrated in a mobile device, for example. The image capture devices may capture video signals corresponding to respective coverage areas and transmit the video signals to the control center 112 to be processed and displayed on display devices 114. The display devices 114 may display captured video or images, as well as, textual data, graphic data, and/or control elements associated with functionality of the surveillance system. Multiple security personnel 116 (e.g., dedicated personnel, supervisors, etc.) may view the content displayed on the display devices 114.

In a typical scenario, different personnel in the control center 112 may have different permissions in the system to view and control different content and surveillance functions. Each security personnel may be assigned to a display device (workstation) access the content by logging in with credentials. Thus, the system may determine which level of access may be granted to that workstation based on the signed in security personnel's credentials. Thus, there may be situations, when a supervisor may need access to content or functionality quickly at a workstation or an unauthorized person may be within view of a display device.

By providing access to content and functionality based on recognition of people within view of a display device, a surveillance system may enhance security and efficiency of surveillance and security operations. Viewers may be recognized through various techniques such as facial recognition, retina recognition, posture recognition, or voice recognition. Displayed content and functionality may then be selected based on authorization level of a recognized viewer. If multiple viewers are present a highest or lowest authorization level may be used subject to override by a viewer with highest authorization level.

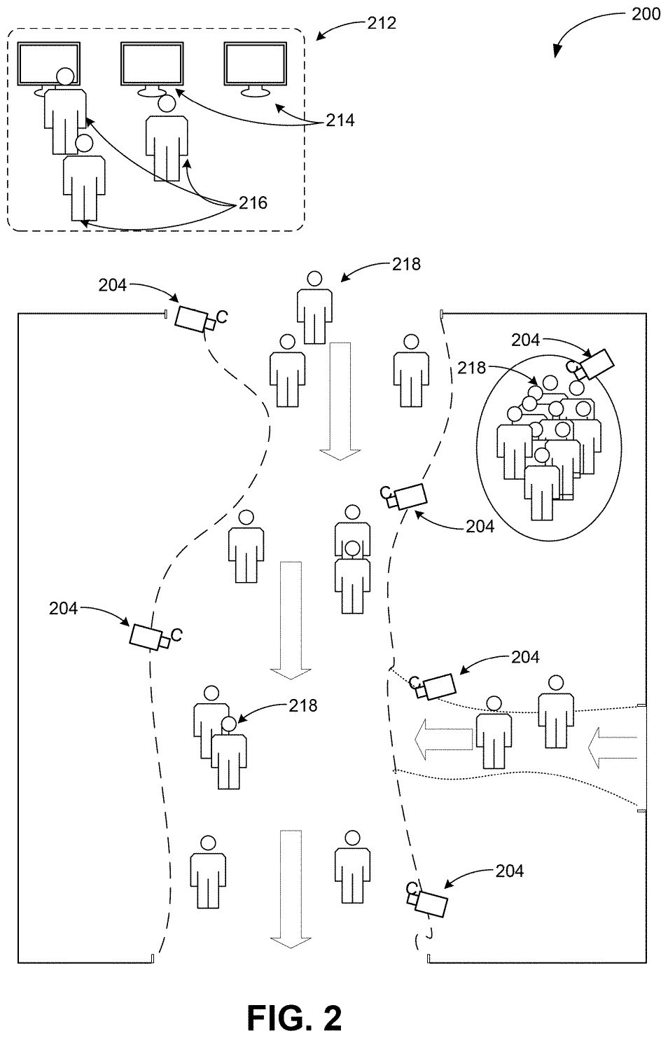

FIG. 2 includes a conceptual illustration of another example environment, where adjustment of displayed content based on recognition of viewer may be implemented, arranged in accordance with at least some embodiments described herein.

Diagram 200 shows another example surveillance environment such as a park, street, or similar location. An example surveillance system for adjustment of displayed content based on recognition of a viewer may include a control center 212, where personnel 216 may observe captured videos and other content of the surveillance environment on display devices 214. The surveillance system may also include a number of image capture devices 204, which may be positioned at strategic locations such as main walkways, connection points, and other gathering areas, where crowds 218 may gather and/or move.

Content presented on the display devices 214 may include image data, video data, audio data, textual data, or graphic data, as well as, control elements associated with functionality of the surveillance system. The content may be displayed to a viewer based on the viewer's credentials. Responsive to detection of another viewer, the displayed content may be modified based on credentials of the other viewer. Viewers may be detected through a variety of techniques and displayed content may be associated with different authority levels. Content may also be blocked from display if a viewer in a restricted list is detected in view of a display device.

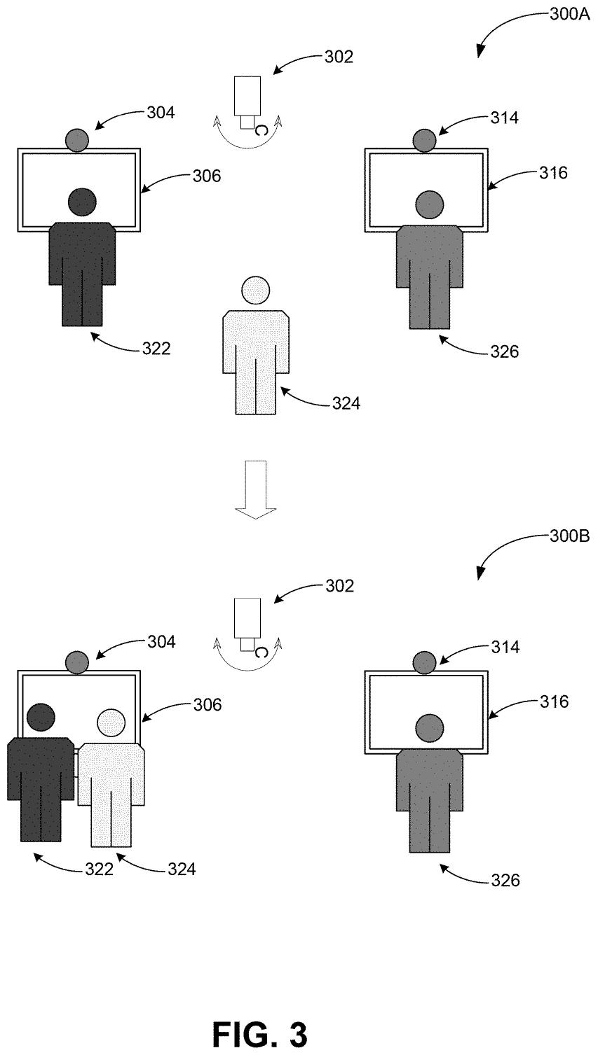

FIG. 3 illustrates an example scenario where displayed content in a surveillance control room may be adjusted based on recognition of viewer, arranged in accordance with at least some embodiments described herein.

The example scenario shown in diagram 300A includes control room display devices 306 and 316 with respective image capture devices 304 and 314. A security personnel 322 may be in front of the display device 306, and another security personnel 326 may be in front of display device 316. The control room may also include a movable image capture device 302 capable of covering the vicinities of both display devices 306 and 316. Furthermore, a supervisor 324 may be present in the control room, but not in front of either display device.

Content displayed on the display device 306 such as captured images or video from surveillance cameras, background information associated with the captured images or video, etc. may be selected (or restricted) based on authentication of credentials of the security personnel 322. The image capture device 304 or the movable image capture device 302 may detect security personnel 322 in front of the display device 306 and authenticate through facial recognition, retina recognition, posture recognition, or voice recognition. Similarly, security personnel 326 may be authenticated through recognition by the image capture device 314 or movable image capture device 302 for the display device 316 and the content displayed on the display device 316 may be adjusted based on the authentication.

Subsequent to the initial configuration, security personnel 322 may request assistance from the supervisor 324, and the supervisor 324 may move to the front of the display device 306 along with security personnel 322 as shown in diagram 300B. Responsive to detection of the supervisor 324 in front of the display device 306, supervisor 324 may be recognized through image capture device 304 or movable image capture device 302. The recognition may include facial recognition, retina recognition, posture recognition, or voice recognition (e.g., through a microphone separate from or attached to the image capture devices). Once the supervisor 324 is recognized, or in other words authenticated, as being in front of the display device 306, the content displayed through the display device 306 may be changed to include content associated with an authorization level of the supervisor 324. For example, the content displayed on the display device 306 for the security personnel 322 may include images of target people in a crowd and any identification (if targets are identified). On the other hand, once the content is changed to correspond to the supervisor's authorization level, background information for each target retrieved from a database may be displayed along with control elements for actions such as contacting on the ground security personnel, storing specific displayed information, etc.

In practical implementations, where the viewers' attention to the displayed content may be important, the recognition based authentication and change of displayed content may be arranged to be gradual so as not to cause a distraction for the viewers (e.g., security personnel 322 and supervisor 324). In some examples, a confirmation user interface may be displayed to allow the supervisor 324 to confirm the change of displayed content. The environment for the example embodiments may include, but is not limited to, stationary, mobile, or field control rooms, offices, or other places where multiple people with different authorization levels may be present to view displayed content.

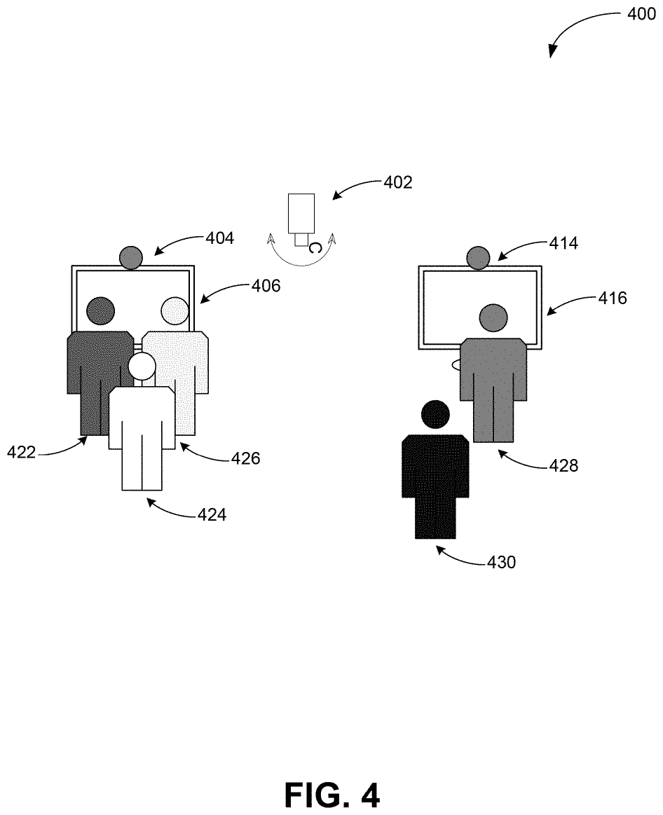

FIG. 4 illustrates additional example scenarios where adjustment of displayed content based on recognition of viewer may be controlled to prevent unauthorized viewing, arranged in accordance with at least some embodiments described herein.

In one of the example scenarios shown in diagram 400, three people, viewers 422, 424, and 426 may be in front of display device 406. Viewers 422, 424, and 426 may have different levels of authorization within the surveillance system or may be assigned to different areas. For example, viewer 422 may be a security personnel assigned to observe a particular area within a venue, viewer 424 may be another security personnel assigned to another area outside the venue, and viewer 426 may be a supervisor. The presence of the viewers 422, 424, and 426 may be detected through optical detection, electromagnetic detection, mechanical detection, or acoustic detection. The detection may be followed by recognition of the viewers through facial recognition, retina recognition, posture recognition, or voice recognition through the image capture device 404 or the movable image capture device 402.

A system (e.g., a security system) managing the content displayed on the display device 406 may determine the authorization levels of the viewers 422, 424, and 426 based on the recognition (authentication) and select content to be displayed based on a highest authorization level or a lowest authorization level among the viewers. In some examples, the system may track eye movements of the viewers to determine if individual viewers in front of the display device 406 are actually looking at the display device. In other examples, a confirmation prompt may be displayed before changing the displayed content based on the highest authorization level detected by the system.

If the system fails to authenticate a viewer in front of a display device, for example, failing to recognize or determining the viewer is not allowed to be in front of that particular display device (e.g., a security personnel assigned to another location or a security personnel who is not supposed to work in that particular time period), the content displayed on the display device may be blocked or restricted. For example, a subset of available content and functionality may be displayed.

The second scenario shown in diagram 400 includes two practical options. First, the viewer 428 in front of the display device 416 may be recognized through the image capture device 414 and the system may determine that the viewer 428 is not supposed to be at that particular workstation at that particular time. Thus, the system may restrict the displayed content. Second, while viewer 428 is authenticated and working in front of the display device 416, another viewer 430 may be detected within a field of view of the display device 416. The system may fail to recognize the viewer 430 or determine that the viewer 430 may not be allowed to be in front of the display device 416. Thus, the system may block the content from being displayed on the display device 416.

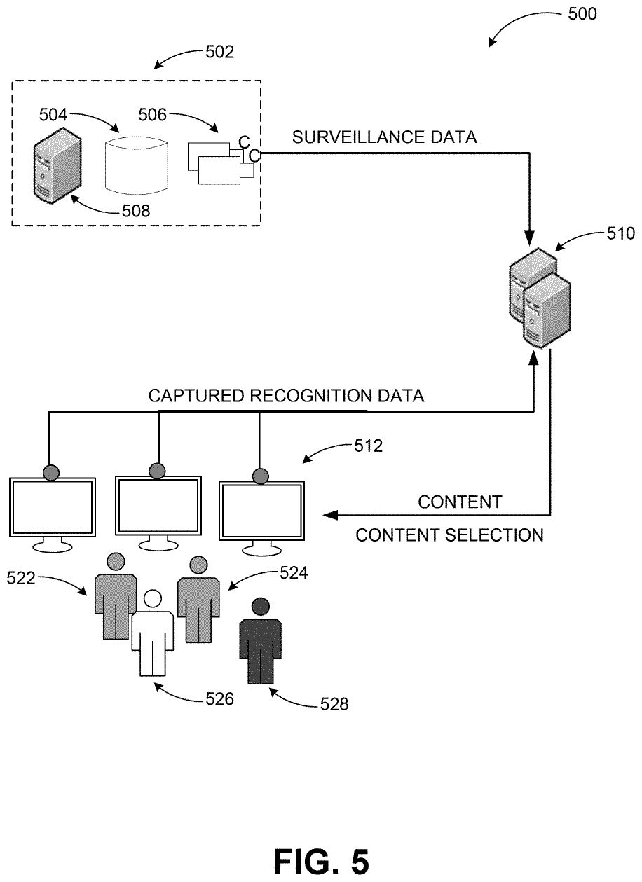

FIG. 5 illustrates an example flow of information in an example system that includes surveillance data sources, processing servers, and displays of a control room, arranged in accordance with at least some embodiments described herein.

Diagram 500 includes a surveillance system 502 with a server 508, a data store 504, and surveillance cameras 506. Surveillance data such as content captured by the surveillance cameras 506 and stored at the data store 504 may be provided by the server 508 to one or more servers 510, which may manage display of content and control of system functionality through display devices 512. Display devices 512 may be at a stationary, mobile, of field control room and include attached or separate image capture devices. The display devices 512 may be viewed by a number of viewers such as security personnel 522 and 524, supervisor 526, and unauthorized person 528.

The servers 510 may provide content from the surveillance system 502 to the display devices 512 based on authentication of a viewer in front of (within a field of view of) each display device. The content may include image data, video data, audio data, textual data, graphic data, or a control element associated with functionality of the surveillance system such as retrieval of additional data, initiation of communication, storage of selected data, control of surveillance cameras, etc.

In some examples, the displayed content may be selected based on authentication (upon recognition of the viewer(s) in front of the displayed device) of a viewer's credentials. For example, if the supervisor 526 is detected by one or more of an optical detection sensor, an electromagnetic detection sensor, a mechanical detection sensor, or an acoustic detection sensor associated with the system and recognized through a facial recognition, a retina recognition, a posture recognition, or a voice recognition, the displayed content may be adjusted to the supervisor's authorization level.

In other examples, a viewer detected in front of a display device may not be recognized, may be recognized as not being allowed to be in front of that display device, or determined to be on a restricted list, the displayed content may be blocked or restricted. The servers 510 may also generate a record that includes detected persons within the field of view of the display device, authenticated persons, displayed content, and/or interactions with the displayed content by respective persons.

In addition to storing content associated with the surveillance activities, the data store 504 may also store information associated with the security personnel allowed to view the display devices. The information may include faces, body images, voices, authorization levels, ranks, etc. of the security personnel. The detection of the viewers in front of a display device may include detection of people within a predefined perimeter (e.g., 3 feet from the display) for a predefined time period (e.g., 3 seconds) to avoid false positives due to detection of passing people. Furthermore, eye movements of detected people may be tracked in some examples to confirm they are actually viewing the display device.

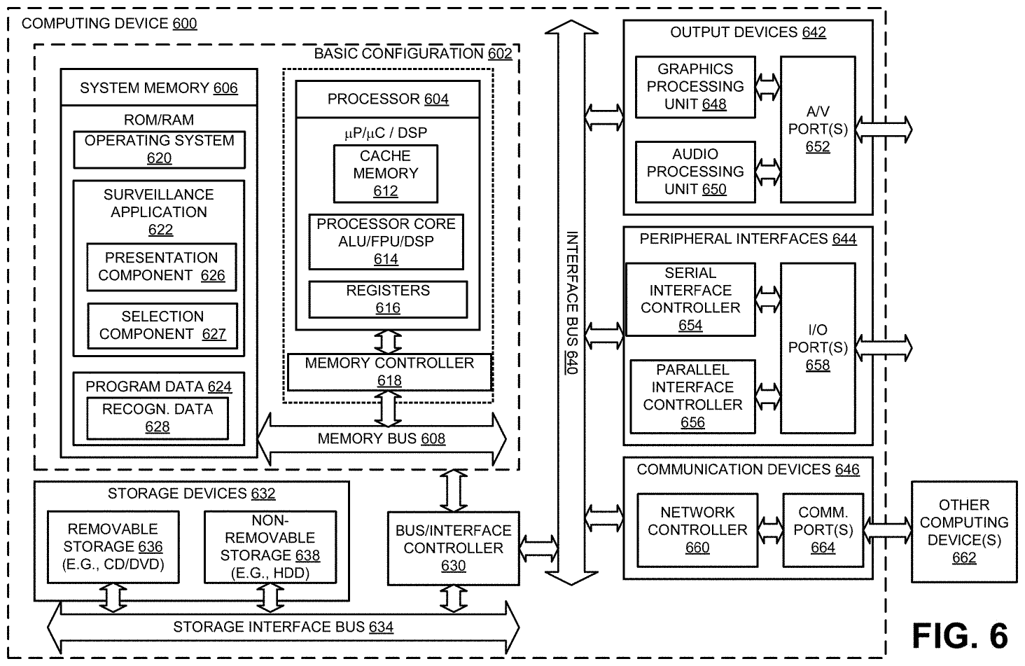

FIG. 6 illustrates a computing device, which may be used for adjustment of displayed content based on recognition of viewer, arranged with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a surveillance application 622, and program data 624. The surveillance application 622 may include a presentation component 626 and a selection component 627. The surveillance application 622, in conjunction with the presentation component 626 and the selection component 627, may be configured to provide adjustment of displayed content based on recognition of viewer. Content that may include data, as well as, functionality may be displayed to a viewer based on the viewer's credentials. Responsive to detection of another viewer, the displayed content may be modified based on credentials of the other viewer. Viewers may be detected through a variety of techniques and displayed content may be associated with different authority levels. Content may also be blocked from display if a viewer in a restricted list is detected in view of a display device. The program data 624 may include, among other data, recognition data 628 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

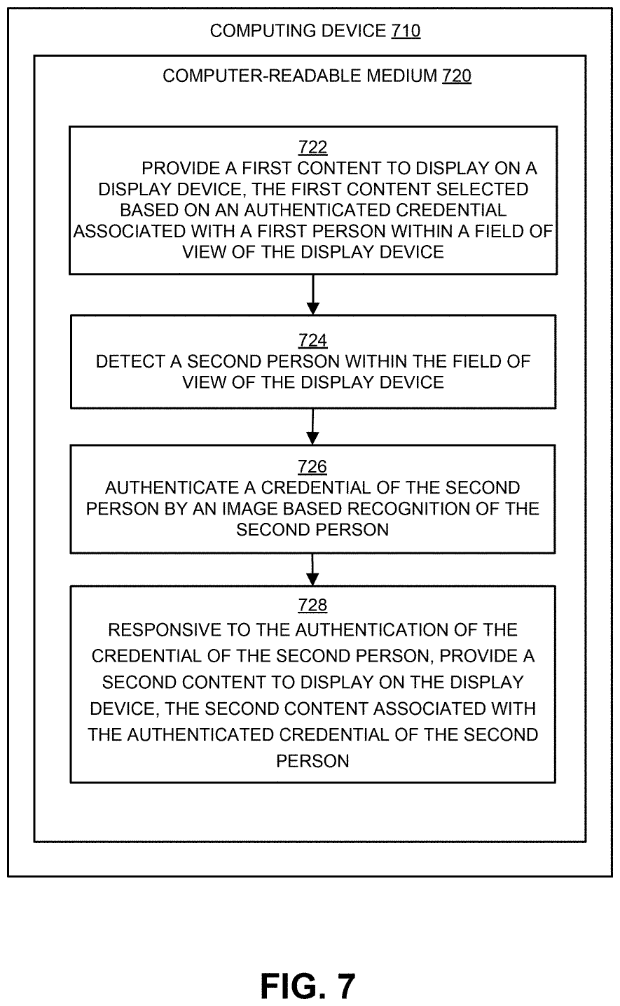

FIG. 7 is a flow diagram illustrating an example method for adjustment of displayed content based on recognition of viewer that may be performed by a computing device such as the computing device in FIG. 6, arranged with at least some embodiments described herein.

Example methods may include one or more operations, functions, or actions as illustrated by one or more of blocks 722, 724, 726, and/or 728, and may in some embodiments be performed by a computing device such as the computing device 710 in FIG. 7. Such operations, functions, or actions in FIG. 7 and in the other figures, in some embodiments, may be combined, eliminated, modified, and/or supplemented with other operations, functions or actions, and need not necessarily be performed in the exact sequence as shown. The operations described in the blocks 722-728 may also be implemented through execution of computer-executable instructions stored in a computer-readable medium such as a computer-readable medium 720 of a computing device 710.

An example process for adjustment of displayed content based on recognition of viewer may begin with block 722, “PROVIDE A FIRST CONTENT TO DISPLAY ON A DISPLAY DEVICE, THE FIRST CONTENT SELECTED BASED ON AN AUTHENTICATED CREDENTIAL ASSOCIATED WITH A FIRST PERSON WITHIN A FIELD OF VIEW OF THE DISPLAY DEVICE”, where content including image data, video data, audio data, textual data, graphic data, and/or a control element associated with a surveillance system functionality may be displayed on a display device based on a credential of a viewer in front of a display device. The credential of the viewer may be detected through recognition of the viewer based on a facial recognition, a retina recognition, a posture recognition, or a voice recognition, for example.

Block 722 may be followed by block 724, “DETECT A SECOND PERSON WITHIN THE FIELD OF VIEW OF THE DISPLAY DEVICE”, where a second viewer may be detected within a predefined perimeter of the display device over a predefined time period, for example. The second viewer may be detected by one or more of optical detection, electromagnetic detection, mechanical detection, or acoustic detection in some examples.

Block 724 may be followed by block 726, “AUTHENTICATE A CREDENTIAL OF THE SECOND PERSON BY AN IMAGE BASED RECOGNITION OF THE SECOND PERSON”, where the second viewer may be authenticated based on one or more of the techniques described above. The second viewer may have higher or lower authorization level compared to the first viewer.

Block 726 may be followed by block 728, “RESPONSIVE TO THE AUTHENTICATION OF THE CREDENTIAL OF THE SECOND PERSON, PROVIDE A SECOND CONTENT TO DISPLAY ON THE DISPLAY DEVICE, THE SECOND CONTENT ASSOCIATED WITH THE AUTHENTICATED CREDENTIAL OF THE SECOND PERSON”, where the displayed content may be adjusted based on the authenticated credential of the second viewer. Depending on the authorization level of the second viewer, the adjusted content may be more or less restricted. For example, for a second viewer with lower authorization level, the adjusted (second) content may be a subset of the first content presented to the first viewer.

The operations included in the example process are for illustration purposes. Adjustment of displayed content based on recognition of viewer may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

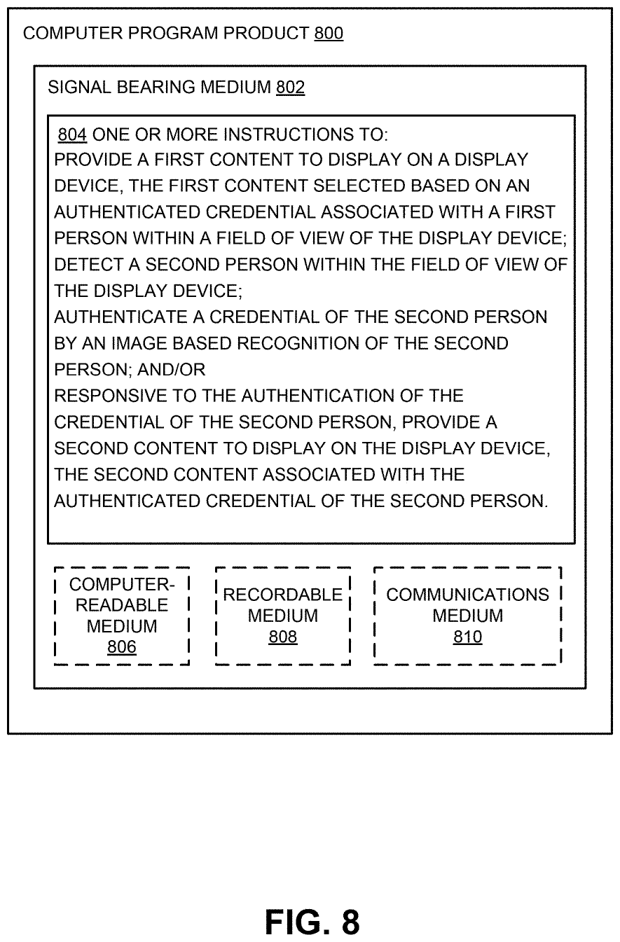

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 604 in FIG. 6, the surveillance application 622 may perform or control performance of one or more of the tasks shown in FIG. 8 in response to the instructions 804 conveyed to the processor 604 by the signal bearing medium 802 to perform actions associated with the adjustment of displayed content based on recognition of viewer as described herein. Some of those instructions may include, for example, provide a first content to display on a display device, the first content selected based on an authenticated credential associated with a first person within a field of view of the display device; detect a second person within the field of view of the display device; authenticate a credential of the second person by an image based recognition of the second person; and/or responsive to the authentication of the credential of the second person, provide a second content to display on the display device, the second content associated with the authenticated credential of the second person, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal bearing medium 802 is conveyed by the communications medium 810 (e.g., a wireless communications medium conforming with the IEEE 802.11 standard).

According to some examples, a method to provide security based content control based on a security verified viewer is described. The method may include providing a first content to display on a display device, wherein the first content is selected based on an authenticated credential associated with a first person within a field of view of the display device, detecting a second person within the field of view of the display device, authenticating a credential of the second person by an image based recognition of the second person; and responsive to the authentication of the credential of the second person, providing a second content to display on the display device, wherein the second content is associated with the authenticated credential of the second person.

According to other examples, authenticating the credential of the second person based on the image based recognition may include performing one or more of a facial recognition, a retina recognition, a posture recognition, or a voice recognition. Detecting the second person within the field of view of the display device may include detecting the second person within a predefined perimeter of the display device over a predefined time period, monitoring eye movements of the second person, and detecting the second person by one or more of optical detection, electromagnetic detection, mechanical detection, or acoustic detection.

According to further examples, providing the first content to display may include providing one or more of image data, video data, audio data, textual data, graphic data, or a control element. The second person may have a higher permission or authority level compared to the first person, and providing the second content to display may include providing additional image data, video data, audio data, textual data, graphic data, or another control element. The second person may have a lower permission or authority level compared to the first person, and providing the second content to display may include providing a subset of the one or more of image data, video data, audio data, textual data, graphic data, or the control element. The method may further include detecting multiple persons within the field of view of the display device, authenticating credentials of one or more of the detected persons based on the image based recognition; and based on the authenticated credentials, providing a third content to display on the display device, wherein the third content is selected based on the authenticated credential of one of a detected person with highest permission or authority level and a detected person with lowest permission or authority level. The method may also include providing a prompt to display on the display device, the prompt presenting an option to select the third content by the detected person with the highest permission or authority level. The method may further include detecting a person within the field of view of the display device, attempting to authenticate a credential of the detected person by image based recognition; and in response to a failure to authenticate the detected person, restricting displayed content on the display device. The method may also include detecting a person within the field of view of the display device, attempting to authenticate a credential of the detected person by image based recognition; and in response to a failure to authenticate the detected person, providing a subset of the first content to display on the display device.

According to yet other examples, the method may also include detecting a person within the field of view of the display device, identifying the detected person by image based recognition; determining that the detected person is on a restriction list; and restricting displayed content on the display device when the detected person is determined to be on the restriction list. The method may further include detecting a person within the field of view of the display device; identifying the detected person by image based recognition; determining that the detected person is on a restriction list; and providing a subset of the first content to display on the display device when the detected person is determined to be on the restriction list. The method may also include presenting an option to confirm a change from the first content to the second content prior to providing the second content to display, and generating a record that includes one or more of detected persons within the field of view of the display device, authenticated persons, displayed content, or interactions with the displayed content by respective persons.

According to further examples, an apparatus configured to provide security based content control based on a security verified viewer is described. The apparatus may include a communication interface configured to facilitate communication between the apparatus and a surveillance system server, a display device, an image capture device, a memory configured to store instructions associated with a surveillance application; and a processor coupled to the communication interface, the display device, the image capture device, and the memory. The processor may configured to execute the surveillance application and perform actions comprising: provide a first content to display on the display device, wherein the first content is selected based on an authenticated credential associated with a first person within a field of view of the display device, detect a second person within the field of view of the display device through the image capture device, authenticate a credential of the second person by an image based recognition of the second person; and responsive to the authentication of the credential of the second person, provide a second content to display on the display device, wherein the second content is associated with the authenticated credential of the second person.

According to other examples, the processor may be further configured to capture an image of the second person through the image capture device, perform one or more of a facial recognition, a retina recognition, a posture recognition, or a voice recognition to authenticate the credential of the second person, detect the second person within the field of view of the display device through detection of the second person within a predefined perimeter of the display device over a predefined time period, detect the second person within the field of view of the display device through detection of eye movements of the second person. The apparatus may further include one or more of an optical detection sensor, an electromagnetic detection sensor, a mechanical detection sensor, or an acoustic detection sensor, wherein the processor may be configured to detect the second person within the field of view of the display device by one or more of optical detection, electromagnetic detection, mechanical detection, or acoustic detection. The processor may be also configured to provide the first content as one or more of image data, video data, audio data, textual data, graphic data, or a control element, determine that the second person has a higher permission or authority level compared to the first person; provide one or more of additional image data, video data, audio data, textual data, graphic data, or another control element as the second content to display, determine that the second person has a lower permission or authority level compared to the first person; and provide one or more of a subset of the one or more of image data, video data, audio data, textual data, graphic data, or the control element as the second content to display. The processor may be also configured to detect multiple persons within the field of view of the display device through the image capture device, authenticate credentials of one or more of the detected persons based on the image based recognition; and based on the authenticated credentials, provide a third content to display on the display device, wherein the third content is selected based on the authenticated credential of one of a detected person with highest permission or authority level and a detected person with lowest permission or authority level.

According to some examples, the processor may be further configured to present an option to select the third content by the detected person with the highest permission or authority level through the display device, detect a person within the field of view of the display device; attempt to authenticate a credential of the detected person by image based recognition; and in response to a failure to authenticate the detected person, restrict displayed content on the display device. The processor may be also configured to detect a person within the field of view of the display device, attempt to authenticate a credential of the detected person by image based recognition; and in response to a failure to authenticate the detected person, provide a subset of the first content to display on the display device. The processor may be further configured to detect a person within the field of view of the display device, identify the detected person by image based recognition, determine that the detected person is on a restriction list; and restrict displayed content on the display device when the detected person is determined to be on the restriction list. The processor may be also configured to detect a person within the field of view of the display device, identify the detected person by image based recognition, determine that the detected person is on a restriction list; and provide a subset of the first content to display on the display device when the detected person is determined to be on the restriction list. The processor may be further configured to present an option through the display device to confirm a change from the first content to the second content prior to provision of the second content to display, generate a record that includes one or more of detected persons within the field of view of the display device, authenticated persons, displayed content, or interactions with the displayed content by respective persons and receive the first content and the second content from one or more of a surveillance camera and a data store. The display device may be communicatively coupled to a workstation in one of a surveillance control center, a mobile command and control system, or a field control center.

According to yet other examples, a surveillance system configured to provide security based content control based on a security verified viewer is described. The surveillance system may include one or more surveillance cameras communicatively coupled to a workstation, a data store communicatively coupled to the workstation and configured to store surveillance related data; and the workstation for management of the surveillance system. The workstation may include a communication interface configured to facilitate communication between the apparatus and a surveillance system server, a display device, an image capture device, a memory configured to store instructions associated with a surveillance application; and a processor coupled to the communication interface, the display device, the image capture device, and the memory. The processor may be configured to execute the surveillance application and may perform actions including: provide a first content to display on the display device, wherein the first content is selected based on an authenticated credential associated with a first person within a field of view of the display device, detect a second person within the field of view of the display device through the image capture device, authenticate a credential of the second person by an image based recognition of the second person; and responsive to the authentication of the credential of the second person, provide a second content to display on the display device, wherein the second content is associated with the authenticated credential of the second person.

According to further examples, the processor may be further configured to capture an image of the second person through the image capture device, perform one or more of a facial recognition, a retina recognition, a posture recognition, or a voice recognition to authenticate the credential of the second person, detect the second person within the field of view of the display device through detection of the second person within a predefined perimeter of the display device over a predefined time period, detect the second person within the field of view of the display device through detection of eye movements of the second person. The surveillance system may further include one or more of an optical detection sensor, an electromagnetic detection sensor, a mechanical detection sensor, or an acoustic detection sensor communicatively coupled to the workstation, wherein the processor may be configured to detect the second person within the field of view of the display device by one or more of optical detection, electromagnetic detection, mechanical detection, or acoustic detection. The processor may be also configured to provide the first content as one or more of image data, video data, audio data, textual data, graphic data, or a control element, determine that the second person has a higher permission or authority level compared to the first person, provide one or more of additional image data, video data, audio data, textual data, graphic data, or another control element as the second content to display, determine that the second person has a lower permission or authority level compared to the first person; and provide one or more of a subset of the one or more of image data, video data, audio data, textual data, graphic data, or the control element as the second content to display. The processor may be further configured to detect multiple persons within the field of view of the display device through the image capture device, authenticate credentials of one or more of the detected persons based on the image based recognition; and based on the authenticated credentials, provide a third content to display on the display device, wherein the third content is selected based on the authenticated credential of one of a detected person with highest permission or authority level and a detected person with lowest permission or authority level.

According to yet other examples, the processor may be further configured to present an option to select the third content by the detected person with the highest permission or authority level through the display device, detect a person within the field of view of the display device; attempt to authenticate a credential of the detected person by image based recognition; and in response to a failure to authenticate the detected person, restrict displayed content on the display device. The processor may be also configured to detect a person within the field of view of the display device, attempt to authenticate a credential of the detected person by image based recognition; and in response to a failure to authenticate the detected person, provide a subset of the first content to display on the display device. The processor may be further configured to detect a person within the field of view of the display device, identify the detected person by image based recognition, determine that the detected person is on a restriction list, restrict displayed content on the display device when the detected person is determined to be on the restriction list, detect a person within the field of view of the display device, identify the detected person by image based recognition, determine that the detected person is on a restriction list, provide a subset of the first content to display on the display device when the detected person is determined to be on the restriction list, present an option through the display device to confirm a change from the first content to the second content prior to provision of the second content to display, generate a record that includes one or more of detected persons within the field of view of the display device, authenticated persons, displayed content, or interactions with the displayed content by respective persons, and receive the first content and the second content from one or more of the one or more surveillance cameras and the data store.

According to further examples, a method to provide content control based on a verified viewer is described. The method may include providing a first content to display on a display device, wherein the first content is selected based on an authenticated credential associated with a first person within a field of view of the display device, detecting a second person within the field of view of the display device, authenticating a credential of the second person by an image based recognition of the second person; and responsive to the authentication of the credential of the second person, providing a second content to display on the display device, wherein the second content is associated with the authenticated credential of the second person.

According to some examples, responsive to the authentication of the credential of the second person, providing the second content to display on the display device may include prior to the authentication, providing a representation of the second content to be displayed. The method may further include responsive to a failure to authenticate, continuing to provide the representation of the second content to be displayed. Authenticating the credential of the second person based on the image based recognition may include performing one or more of a facial recognition, a retina recognition, a posture recognition, or a voice recognition. Detecting the second person within the field of view of the display device may include detecting the second person within a predefined perimeter of the display device over a predefined time period, monitoring eye movements of the second person, or detecting the second person by one or more of optical detection, electromagnetic detection, mechanical detection, or acoustic detection. Providing the first content to display may include providing one or more of image data, video data, audio data, textual data, graphic data, or a control element. The second person may have a higher permission or authority level compared to the first person, and providing the second content to display may include providing additional image data, video data, audio data, textual data, graphic data, or another control element. The second person may have a lower permission or authority level compared to the first person, and providing the second content to display may include providing a subset of the one or more of image data, video data, audio data, textual data, graphic data, or the control element.

According to other examples, the method may also include detecting multiple persons within the field of view of the display device, authenticating credentials of one or more of the detected persons based on the image based recognition; based on the authenticated credentials, providing a third content to display on the display device, wherein the third content is selected based on the authenticated credential of one of a detected person with highest permission or authority level and a detected person with lowest permission or authority level, and providing a prompt to display on the display device, the prompt presenting an option to select the third content by the detected person with the highest permission or authority level. The method may further include detecting a person within the field of view of the display device, attempting to authenticate a credential of the detected person by image based recognition, and in response to a failure to authenticate the detected person, restricting displayed content on the display device. The method may also include detecting a person within the field of view of the display device, attempting to authenticate a credential of the detected person by image based recognition; and in response to a failure to authenticate the detected person, providing a subset of the first content to display on the display device. The method may further include detecting a person within the field of view of the display device, identifying the detected person by image based recognition, determining that the detected person is on a restriction list, restricting displayed content on the display device when the detected person is determined to be on the restriction list or providing a subset of the first content to display on the display device when the detected person is determined to be on the restriction list. The method may also include presenting an option to confirm a change from the first content to the second content prior to providing the second content to display and generating a record that includes one or more of detected persons within the field of view of the display device, authenticated persons, displayed content, or interactions with the displayed content by respective persons.

According to yet other examples, an apparatus configured to provide content control based on a verified viewer is described. The apparatus may include a communication interface configured to facilitate communication between the apparatus, a content server, and an authentication server, a display device, an image capture device, a memory configured to store instructions associated with a content display application; and a processor coupled to the communication interface, the display device, the image capture device, and the memory. The processor may be configured to execute the content display application and perform actions include provide a first content to display on the display device, wherein the first content is selected based on an authenticated credential associated with a first person within a field of view of the display device, detect a second person within the field of view of the display device through the image capture device, authenticate a credential of the second person by an image based recognition of the second person; and responsive to the authentication of the credential of the second person, provide a second content to display on the display device, wherein the second content is associated with the authenticated credential of the second person.

According to some examples, the processor may be further configured to prior to the authentication, provide a representation of the second content to be displayed and responsive to a failure to authenticate, continue to provide the representation of the second content to be displayed. The processor may be further configured to capture an image of the second person through the image capture device, perform one or more of a facial recognition, a retina recognition, a posture recognition, or a voice recognition to authenticate the credential of the second person, detect the second person within the field of view of the display device through detection of the second person within a predefined perimeter of the display device over a predefined time period, and detect the second person within the field of view of the display device through detection of eye movements of the second person. The apparatus may further include one or more of an optical detection sensor, an electromagnetic detection sensor, a mechanical detection sensor, or an acoustic detection sensor, wherein the processor may be configured to detect the second person within the field of view of the display device by one or more of optical detection, electromagnetic detection, mechanical detection, or acoustic detection. The processor may be further configured to provide the first content as one or more of image data, video data, audio data, textual data, graphic data, or a control element, determine that the second person has a higher permission or authority level compared to the first person, provide one or more of additional image data, video data, audio data, textual data, graphic data, or another control element as the second content to display, determine that the second person has a lower permission or authority level compared to the first person; and provide a subset of the one or more of image data, video data, audio data, textual data, graphic data, or the control element as the second content to display.

According to other examples, the processor may be further configured to detect multiple persons within the field of view of the display device through the image capture device, authenticate credentials of one or more of the detected persons based on the image based recognition; and based on the authenticated credentials, provide a third content to display on the display device, wherein the third content is selected based on the authenticated credential of one of a detected person with highest permission or authority level and a detected person with lowest permission or authority level. The processor may be also configured to present an option to select the third content by the detected person with the highest permission or authority level through the display device, detect a person within the field of view of the display device, attempt to authenticate a credential of the detected person by image based recognition; and in response to a failure to authenticate the detected person, restrict displayed content on the display device. The processor may be further configured to detect a person within the field of view of the display device, attempt to authenticate a credential of the detected person by image based recognition; and in response to a failure to authenticate the detected person, provide a subset of the first content to display on the display device. The processor may be also configured to detect a person within the field of view of the display device, identify the detected person by image based recognition, determine that the detected person is on a restriction list; and restrict displayed content on the display device when the detected person is determined to be on the restriction list. The processor may be further configured to detect a person within the field of view of the display device, identify the detected person by image based recognition, determine that the detected person is on a restriction list, provide a subset of the first content to display on the display device when the detected person is determined to be on the restriction list, present an option through the display device to confirm a change from the first content to the second content prior to provision of the second content to display, generate a record that includes one or more of detected persons within the field of view of the display device, authenticated persons, displayed content, or interactions with the displayed content by respective persons and receive the first content and the second content from the content server.

There are various vehicles by which processes and/or systems and/or other technologies described herein may be effected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and designing the circuitry and/or writing the code for the software and/or firmware would be possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to provide security based content control based on a security verified viewer, the method comprising:
detecting a first person within a field of view of a display device;
authenticating a credential of the first person by an image based recognition of the first person;
selecting a first content based on the authenticated credential of the first person;
providing the first content to display on the display device;
detecting a second person within the field of view of the display device while the first person is still within the field of view of the display device;
authenticating a credential of the second person by an image based recognition of the second person;
selecting a second content based on whether the authenticated credential of the first person has a higher permission or authority level or a lower permission or authority level compared to the authenticated credential of the second person; and
providing the second content to display on the display device.

2. The method of claim 1, wherein authenticating the credential of the first person or the second person based on the image based recognition comprises:
performing one or more of a facial recognition, a retina recognition, a posture recognition, or a voice recognition.

3. The method of claim 1, wherein detecting the second person within the field of view of the display device comprises:
detecting the second person within a predefined perimeter of the display device over a predefined time period by one or more of optical detection, electromagnetic detection, mechanical detection, or acoustic detection.

4. The method of claim 1, wherein detecting the second person within the field of view of the display device further comprises:
monitoring eye movements of the second person.

5. (canceled)

6. (canceled)

7. The method of claim 1, wherein the second person has a higher permission or authority level compared to the first person, and providing the second content to display comprises one or more of:
providing additional image data, video data, audio data, textual data, graphic data, or another control element; or
providing a subset of the one or more of image data, video data, audio data, textual data, graphic data, or the control element.

8. (canceled)

9. (canceled)

10. The method of claim 1, further comprising:
providing a prompt to display on the display device, the prompt presenting an option to select the second content by one of the detected first person or the second person with the higher permission or authority level.

11.-15. (canceled)

16. The method of claim 1, further comprising:
generating a record that includes one or more of detected persons within the field of view of the display device, authenticated persons, displayed content, or interactions with the displayed content by respective persons.

17. An apparatus configured to provide security based content control based on a security verified viewer, the apparatus comprising:
a communication interface configured to facilitate communication between the apparatus and a surveillance system server;
a display device;
an image capture device;
a memory configured to store instructions associated with a surveillance application; and
a processor coupled to the communication interface, the display device, the image capture device, and the memory, wherein the processor is configured to execute the surveillance application and perform actions comprising:
detect a first person within a field of view of a display device through the image capture device;
authenticate a credential of the first person by an image based recognition of the first person;
select a first content based on the authenticated credential of the first person;
provide the first content to display on the display device;
detect a second person within the field of view of the display device through the image capture device while the first person is still within the field of view of the display device;
authenticate a credential of the second person by an image based recognition of the second person;
select a second content based on whether the authenticated credential of the first person has a higher permission or authority level or a lower permission or authority level compared to the authenticated credential of the second person; and
provide the second content to display on the display device.

18. (canceled)

19. (canceled)

20. The apparatus of claim 17, wherein the processor is configured to detect the second person within the field of view of the display device through detection of eye movements of the second person.

21. The apparatus of claim 17, further comprising one or more of an optical detection sensor, an electromagnetic detection sensor, a mechanical detection sensor, or an acoustic detection sensor, wherein the processor is configured to detect the second person within the field of view of the display device by one or more of optical detection, electromagnetic detection, mechanical detection, or acoustic detection.

22. The apparatus of claim 17, wherein the processor is configured to:
provide the first content as one or more of image data, video data, audio data, textual data, graphic data, or a control element; and
provide the second content as one or more of additional image data, video data, audio data, textual data, graphic data, or another control element as the second content to display or one or more of a subset of the one or more of image data, video data, audio data, textual data, graphic data, or the control element as the second content to display.

23.-25. (canceled)

26. The apparatus of claim 17, wherein the processor is further configured to:
present an option to select the second content by the detected person with the higher permission or authority level through the display device.

27. The apparatus of claim 17, wherein the processor is further configured to:
detect a third person within the field of view of the display device;
attempt to authenticate a credential of the detected third person by image based recognition; and
in response to a failure to authenticate the detected third person, one or more of:
restrict displayed content on the display device, or
provide a subset of the first content to display on the display device.

28. (canceled)

29. The apparatus of claim 17, wherein the processor is further configured to:
detect a third person within the field of view of the display device;
identify the detected third person by image based recognition;
determine that the detected third person is on a restriction list; and
responsive to the determination, one or more of:
restrict displayed content on the display device, or
provide a subset of the first content to display on the display device.

30.-32. (canceled)

33. The apparatus of claim 17, wherein the display device is communicatively coupled to a workstation in one of a surveillance control center, a mobile command and control system, or a field control center, and the processor is further configured to:
receive the first content and the second content from one or more of a surveillance camera and a data store.

34. (canceled)

35. A surveillance system configured to provide security based content control based on a security verified viewer, the system comprising:
one or more surveillance cameras communicatively coupled to a workstation;
a data store communicatively coupled to the workstation and configured to store surveillance related data; and
the workstation for management of the surveillance system, wherein the workstation comprises:
a communication interface configured to facilitate communication between the apparatus and a surveillance system server;
a display device;
an image capture device;
a memory configured to store instructions associated with a surveillance application; and
a processor coupled to the communication interface, the display device, the image capture device, and the memory, wherein the processor is configured to execute the surveillance application and perform actions comprising:
provide a first content to display on the display device, wherein the first content is selected based on an authenticated credential associated with a first person within a field of view of the display device;
detect a second person within the field of view of the display device through the image capture device while the first person is still within the field of view of the display device;
authenticate a credential of the second person by an image based recognition of the second person;
select a second content based on whether the authenticated credential of the first person has a higher permission or authority level or a lower permission or authority level compared to the authenticated credential of the second person; and
provide the second content to display on the display device.

36. The surveillance system of claim 35, wherein the processor is configured to:
perform one or more of a facial recognition, a retina recognition, a posture recognition, or a voice recognition to authenticate the credential of the second person.

37. (canceled)

38. (canceled)

39. The surveillance system of claim 35, further comprising one or more of an optical detection sensor, an electromagnetic detection sensor, a mechanical detection sensor, or an acoustic detection sensor communicatively coupled to the workstation, wherein the processor is configured to detect the second person within the field of view of the display device by one or more of optical detection, electromagnetic detection, mechanical detection, or acoustic detection.

40. (canceled)

41. The surveillance system of claim 35, wherein the processor is configured to:
determine that the second person has a higher permission or authority level compared to the first person; and
one or more of:
provide one or more of additional image data, video data, audio data, textual data, graphic data, or another control element as the second content to display, or
provide one or more of a subset of the one or more of image data, video data, audio data, textual data, graphic data, or the control element as the second content to display.

42. (canceled)

43. (canceled)

44. The surveillance system of claim 35, wherein the processor is further configured to:
present an option to select the select content by the detected person with the higher permission or authority level through the display device.

45.-88. (canceled)
